(19) United States
(12) Patent Application Publication
(10) Pub. No.: US 2022/0338481 A1
(43) Pub. Date: Oct. 27, 2022

(54) PROBIOTIC AND CHEMICAL CONTROL OF BIOFILMS

(71) Applicant: Diversey, Inc., Fort Mill, SC (US)

(72) Inventors: Xiaobao Li, Charlotte, NC (US); Bret Glembocki, Aurora, CO (US); Dale Grinstead, Highlands, NC (US); Kenneth Roach, Racine, WI (US); David Limbaugh, Seattle, WA (US)

(21) Appl. No.: 17/618,582

(22) PCT Filed: Jun. 19, 2020
(86) PCT No.: PCT/US2020/038630

§ 371 Date: Dec. 13, 2021

Related U.S. Application Data
(60) Provisional application No. 62/864,829, filed on Jun. 21, 2019.

(51) Int. Cl. A01N 63/20; A01P 1/00; A01N 59/00; A01N 33/12; A01N 63/25; A01N 63/22

(52) U.S. Cl. CPC A01N 63/20; A01P 1/00; A01N 59/00; A01N 33/12; A01N 63/25; A01N 63/22

(57) ABSTRACT

A method of controlling a biofilm comprises contacting the biofilm with probiotic species and contacting the biofilm with chemical disinfectant. The biofilm may be contacted with the probiotic species and the chemical disinfectant simultaneously or sequentially. The method provides a higher reduction in the amount of at least one microbial species in the biofilm, compared to a similar method applying only the chemical disinfectant. Furthermore, the method may provide an unexpected synergy between the probiotic species and the chemical disinfectant in controlling the biofilm.

### CROSS-REFERENCE TO RELATED APPLICATION

This application claims priority to U.S. Provisional Application No. 62/864,829 filed Jun. 21, 2019.

### TECHNICAL FIELD

This disclosure relates to methods of controlling biofilms, more particularly to methods of controlling biofilms using probiotic species and chemical disinfectant.

### BACKGROUND

Biofilms are complex communities of microorganisms that are commonly found on a variety of substrates or surfaces. Though primarily populated by bacteria, biofilms can also contain many different individual types of microorganisms, e.g., bacteria, archaea, protozoa and algae. The formation of biofilms can be thought of as a developmental process in which a few free (planktonic) bacteria adhere to a solid surface and, in response to appropriate signals, initiate the formation of a complex microcolony existing as a community of bacteria and other organisms. Bacteria within biofilms are usually embedded within a matrix, which can consist of protein, polysaccharide, nucleic acids, or combinations of these macromolecules. The matrix is a critical feature of the biofilm that protects the inhabiting organisms from antiseptics, microbicides, and host cells.

Biofilms are very difficult to control and antimicrobial agents are rarely tested for efficacy against biofilms. Most current lab test methods address planktonic bacteria. The few test methods that address bacteria in a biofilm are restricted to single species biofilms. It has been estimated that bacteria within biofilms are upwards of 1,000-fold more resistant to conventional biocides. Bacteria in environmental settings exist as a biofilm greater than 90% of the time. Often, the biofilms shelter pathogens allowing rapid repopulation following cleaning. Therefore, effective treatment methods for controlling and inhibiting the growth of biofilms are necessary.

### SUMMARY

In one aspect, a method of controlling a biofilm comprises contacting the biofilm with probiotic species and contacting the biofilm with chemical disinfectant. The biofilm may be contacted with the probiotic species and the chemical disinfectant simultaneously or sequentially. The disclosed method provides a higher reduction in the amount of at least one microbial species in the biofilm, compared to a similar method applying only the chemical disinfectant. In some embodiments, the disclosed method provides an unexpected synergy between the probiotic species and the chemical disinfectant in controlling the biofilm.

Other aspects of the disclosure will become apparent by consideration of the detailed description.

### DETAILED DESCRIPTION

The present disclosure generally relates to methods of controlling biofilms that comprise contacting the biofilm with probiotic species and contacting the biofilm with a chemical disinfectant. The biofilm may be contacted with the probiotic species and the chemical disinfectant simultaneously or sequentially.

The term “controlling” or grammatical variations thereof, as used herein, means and includes disrupting biofilms, reducing the formation of biofilm, preventing the formation of biofilm, decreasing the growth of biofilm, or any combination thereof.

The terms “microbial species”, “microorganism” and “microbe”, as used interchangeably herein, refer to any microscopic organism which may be single-celled or multicellular. For example, microbial species may include any species of bacteria, algae, fungi and protists.

The term “biofilm”, as used herein, refers to any group of microorganisms that are embedded in a matrix of polymeric material and other macromolecules. Biofilm may contain either single type of microbial species (“single-species biofilm”), or at least two types of microbial species. Biofilm may readily adhere to a wide variety of surfaces. The term “multiple-species biofilm” refers to any biofilm that contains at least two types of microbial species.

The term “probiotic species”, as used herein, refers to any species that in the presence of a biofilm will counteract the ability of the biofilm to grow or establish a complex matrix environment.

The term “quaternary ammonium”, as used herein, refers to any substituted ammonium compound having four substituents (e.g., alkyl or heterocyclic substitutent of any size or chain length) and carrying a counter ion (e.g., halide, sulfate or similar counter ion). Exemplary quaternary ammonium compounds include, but are not limited to, alkyl dimethyl benzyl ammonium chloride, didecyl dimethyl ammonium chloride, dialkyl dimethyl ammonium chloride, and twin-chain or dialkyl quaternaries (e.g. didecyl dimethyl ammonium bromide and dioctyl dimethyl ammonium bromide).

The amount of a component in a composition as disclosed herein is expressed “by weight” or “wt %”, which refers to the percentage of the component's weight in the total weight of the composition. Unless indicated otherwise, all concentrations are expressed as weight percentage concentrations.

The term “effective amount” refers to an amount effective that would achieve a desired effect or result. For example, an effective amount of a chemical disinfectant refers to the amount of such chemical disinfectant to achieve a level of antimicrobial activity, which can be measured with a standardized test known in the art. An effective amount of a chemical disinfectant composition may be determined by known methods and may vary according to factors such as the microbial strains, test media, temperature, and other conditions.

The term “substantially free”, “free”, “substantially no”, or “no” refers to a disinfectant composition that does not contain a particular compound, or to which a particular compound has not been added to the disinfectant composition. Should the particular compound be present through contamination, the amount of such particular compound shall be less than 0.5% by weight, preferably less than 0.1% by weight.

The terms “comprise”, “include”, “have”, “contain,” or grammatical variations thereof, as used herein, are intended to be open-ended transitional phrases, terms, or words that do not preclude the possibility of additional acts or structures. The singular forms “a,” “an” and “the” include plural references unless the context clearly dictates otherwise. Where the term “comprising” is used, the present disclosure contemplates “comprising,” “consisting of”, or “consisting essentially of” elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated. All possible combinations of numerical values between and including the lowest value and the highest value enumerated are to be considered to be expressly stated in the present disclosure.

The method of controlling biofilm comprises contacting the biofilm with probiotic species and contacting the biofilm with chemical disinfectant. The disclosed method provides a higher reduction in the amount of at least one microbial species in the biofilm, compared to a similar method applying only the chemical disinfectant. The biofilm may be contacted with the probiotic species and the chemical disinfectant simultaneously or sequentially. The combination of probiotic species and chemical disinfectant provides an effective control of biofilm, while limiting the need for strong antimicrobial chemical treatment.

Biofilm

The methods described herein may be used to control the biofilm that is composed of a single species or a multiple species (i.e., at least two species) of microbials. The biofilm may comprise bacteria, archaea, protozoa, algae, or any combination of these microbials.

In some embodiments, the biofilm comprises bacteria. The bacteria may be Gram-positive or Gram-negative. Furthermore, the bacteria may be anaerobic, aerobic, or a facultative anaerobe.

In some embodiments, the biofilm may comprise Aspergillus niger, Listeria innocua, Psuedomonas aeruginosa, Staphylococcus aureus, or any combination thereof.

In some embodiments, the single-species biofilm is composed of Staphylococcus aureus. In some embodiments, the single-species biofilm is composed of Psuedomonas aeruginosa.

In some embodiments, the multiple-species biofilm may be composed of Listeria innocua and Staphylococcus aureus. In some embodiments, the multiple-species biofilm may be composed of Listeria innocua and Psuedomonas aeruginosa. In some embodiments, the multiple-species biofilm may be composed of Staphylococcus aureus and Psuedomonas aeruginosa. In some embodiments, the multiple-species biofilm may be composed of Listeria innocua, Staphylococcus aureus, and Psuedomonas aeruginosa. In some embodiments, the multiple-species biofilm may have additional microbial species that may be well known to grow in combination with Listeria innocua, Staphylococcus aureus, and Psuedomonas aeruginosa.

Probiotic Treatment

The probiotic species may be any microorganism capable of counteracting at least one of the obstacles associated with ti ting biofilms due to formation of a complex matrix. The probiotic species may be spore-forming or non-spore-forming bacteria. The probiotic species may be Acetoanaerobium, Aerococcaceae, Bacillaceae, Carnobacteriaceae, Enterococcaceae, Lactobacillaceae, Leuconostocaceae, Paembacillaceae, Propiombacteriaceae, Enterobacteriaceae, Pseudomonadaceae, Streptococcaceae, or any combination thereof. The probiotic species may be Citrobacter freundii, Lactobacillus acidophllus, Lactococcuslactin, Lactobacillus salivarius, Paenibacillus polymyxa, and Escherichia coli, or any combination thereof.

In some embodiments, the probiotic species is Lactococcus lactis. In some embodiments, the probiotic species is Escherichia coli. In some embodiments, the probiotic species is Paenibacillus polymyxa.

Chemical Disinfectant Treatment

The chemical disinfectant may comprise a disinfecting agent selected from quaternary ammonium, hydrogen peroxide, glutaraldehyde, sodium hypochlorite, alcohols, peroxy or peroxo acids, sulfur-nitrogen compounds, hypochlorous aid, chlorine dioxide, ozone, organic acids, acid-anionics, or any combination thereof. In some embodiments, the chemical disinfectant comprises quaternary ammonium. In some embodiments, the chemical disinfectant comprises hydrogen peroxide.

The chemical disinfectant may comprise a disinfecting agent in an effective amount to reduce the amount of at least one microbial species in the biofilm when used in the method disclosed herein. The chemical disinfectant may comprise at least 0.005 wt %, at least 0.01 wt %, at least 0.1 wt %, at least 1 wt %, at least 10 wt %, at least 20 wt %, at least 30 wt %, at least about 40 wt %, at least 50 wt %, at least 60 wt %, at least 70 wt %, at least 80 wt %, or at least 90 wt % of disinfecting agent based on total weight of the chemical disinfectant.

The chemical disinfectant may comprise from about 0.005 wt % to about 10 wt % of disinfecting agent based on total weight of the chemical disinfectant. The chemical disinfectant may comprise from about 0.005 wt % to about 1 wt %, from about 0.005 wt % to about 3 wt %, from about 0.005 wt % to about 5 wt %, about 0.01 wt % to about 1 wt %, from about 0.01 wt % to about 3 wt %, from about 0.01 wt % to about 5 wt %, from about 0.01 wt % to about 8 wt %, from about 0.1 wt % to about 1 wt %, from about 0.1 wt % to about 3 wt %, from about 0.1 wt % to about 5 wt %, from about 0.1 wt % to about 8 wt %, from about 0.1 wt % to about 10 wt %, from about 1 wt % to about 3 wt %, from about 1 wt % to about 5 wt %, from about 1 wt % to about 8 wt %, from about 1 wt % to about 10 wt %, from about 3 wt % to about 5 wt %, from about 3 wt % to about 8 wt %, from about 3 wt % to about 10 wt %, from about 5 wt % to about 8 wt %, from about 5 wt % to about 10 wt %, or from about 8 wt % to about 10 wt % of disinfecting agent based on total weight of the chemical disinfectant.

The chemical disinfectant may comprise from about 0.005 wt % to about 10% by weight of quaternary ammonium based on total weight of the chemical disinfectant. The chemical disinfectant may comprise from about 0.005 wt % to about 1 wt %, from about 0.005 wt % to about 3 wt %, from about 0.005 wt % to about 5 wt %, from about 0.01% to about 0.1%, from about 0.01% to about 1%, from about 0.01% to about 3%, from about 0.01% to about 5%, from about 0.01% to about 8%, from about 0.1% to about 1%, from about 0.1% to about 3%, from about 0.1% to about 5%, from about 0.1% to about 8%, from about 0.1% to about 10%, from about 1% to about 3%, from about 1% to about 5%, from about 1% to about 8%, from about 1% to about 10%, from about 3% to about 5%, from about 3% to about 8%, from about 3% to about 10%, from about 5% to about 8%, from about 5% to about 10%, or from about 8% to about 10% by weight of quaternary ammonium based on total weight of the chemical disinfectant. In some embodiments, the chemical disinfectant may comprise about 0.07% by weight of quaternary ammonium based on total weight of the chemical disinfectant.

The chemical disinfectant may comprise from about 0.005 wt % to about 10% by weight of hydrogen peroxide based on total weight of the chemical disinfectant. The chemical disinfectant may comprise from about 0.005% to about 0.1%, from about 0.005% to about 1%, from about 0.005% to about 3%, from about 0.005% to about 5%, from about 0.005% to about 8%, from about 0.01% to about 0.1%, from about 0.01% to about 1%, from about 0.01% to about 3%, from about 0.01% to about 5%, from about 0.01% to about 8%, from about 0.1% to about 1%, from about 0.1% to about 3%, from about 0.1% to about 5%, from about 0.1% to about 8%, from about 0.1% to about 10%, from about 1% to about 3%, from about 1% to about 5%, from about 1% to about 8%, from about 1% to about 10%, from about 3% to about 5%, from about 3% to about 8%, from about 3% to about 10%, from about 5% to about 8%, from about 5% to about 10%, or from about 8% to about 10% by weight of hydrogen peroxide based on total weight of the chemical disinfectant. In some embodiments, the chemical disinfectant may comprise about 0.25% by weight of hydrogen peroxide based on total weight of the chemical disinfectant.

Method of Controlling Biofilm

The method of controlling a biofilm of the present disclosure comprises: contacting the biofilm with probiotic species; and

contacting the biofilm with chemical disinfectant,

wherein the method provides a higher reduction in the amount of at least one microbial species in the biofilm, compared to a similar method applying only the chemical disinfectant.

The biofilm may be contacted with the probiotic species and the chemical disinfectant sequentially. See Examples 1-5. In some embodiments, the biofilm may be contacted with the probiotic species prior to contacting with the chemical disinfectant. In some embodiments, the biofilm may be contacted with the chemical disinfectant prior to contacting with the probiotic species. Furthermore, there may be an interval of time between contacting the biofilm with the probiotic species and contacting the biofilm with the chemical disinfectant.

The biofilm may be contacted with the probiotic species and the chemical disinfectant simultaneously. See Example 6. In some embodiments, the probiotic species and the chemical disinfectant may be contained within a single composition. In some embodiments, the probiotic species and the chemical disinfectant may be contained in two separate compositions, and the two separate compositions are added to the biofilm at the same time.

The disclosed method is suitable for controlling a single-species biofilm. See Examples 1-3 for controlling the biofilm composed of P. aeruginosa; and Example 4 for controlling the biofilm composed of S. aureus. The disclosed method is also suitable for controlling a multiple-species biofilm. See Example 5 for controlling the biofilm composed of S. aureus, L. innocua, and P. aeruginosa.

The method of present disclosure provides a higher reduction in the amount of at least one microbial species in the biofilm, compared to a similar method applying only the chemical disinfectant. In some embodiments, the disclosed method provides a synergistic effect between the probiotic species and the chemical disinfectant in controlling the biofilm. See Example Section.

The biofilm may be on a surface. Non-limiting examples of suitable surface may include appliance surface, carpet, curtain, door, door handle, drain, electronic device surface, filter, floor, floor care machine and component, countertop, furniture surface, food contact surface, human skin, HVAC component, ducting, mattress surface, pipe, shower head, sink, tubing, wall, or any combination thereof. The filters may be air filters or water filters. The surface may be a floor. The surface may be a countertop. The surface may be a food contact surface. The food contact surface may be a pipe. The surface may be a non-food contact surface.

The disclosed method of controlling biofilm may further comprise using an applicator to add the probiotic species to the biofilm, to apply the chemical disinfectant to the biofilm, or both. Suitable applicators may include, but not limited to, applicator tip, broom, brush, cloth, container, dispensing system, dosing and dispensing system, floor cleaning machine, mop, sponge, spray device, squeegee, towel, or any combination thereof. The probiotic species and/or the chemical disinfectant may be transferred to the applicator prior to contacting the biofilm. For example, the chemical disinfectant and/or the probiotic species may be transferred to a mop by dipping the mop into a composition containing the chemical disinfectant and/or the probiotic species prior to contacting the biofilm.

### EXAMPLES

The following non-limiting examples illustrate the compositions of the present disclosure and methods of use thereof.

### Example 1

Example 1 tested the microefficacy of probiotic treatment and/or chemical disinfectant treatments against P. aeruginosa biofilms. E. coli was used for probiotic treatment. Hydrogen peroxide or quaternary ammonium was used for chemical disinfectant treatment.

Biofilms of the selected microbial species were grown in CDC biofilm reactor according to the EPA Standard Operating Procedure Method Number MB-19-02. Culturing of Biofilm involved a batch phase for 24 hours, followed by a flow phase for another 24 hours. The biofilms were grown at 21° C., with a rotating speed of 60 rpm of the rotator of the CDC biofilm reactor. For the batch phase, the biofilm was cultured in 40,000 mg/L tryptic soy broth (TSB); for the flow phase, the biofilm was cultured in 4,000 mg/L TSB.

A probiotic treatment was performed by adding probiotic species (E. coli) to the CDC biofilm reactor at the same time that the biofilm species (P. aeruginosa) was added at a 1:1 ratio. Then, both microbial species were allowed to grow according to the procedure described above (EPA method number MB-19-02).

A chemical disinfectant treatment was performed according to the EPA Standard Operating Procedure Method Number MB-20-01. Two chemical disinfectants were chosen for testing at a contact time of 3 minutes. One chemical disinfectant contained 0.27% hydrogen peroxide (“Hydrogen Peroxide”) as the disinfecting agent; the other chemical disinfectant contained 0.066% quaternary ammonium (“Quat Ammonium”) as the disinfecting agent.

TABLE 1 showed the microefficacy of probiotic treatment and/or chemical disinfectant treatments against P. aeruginos in biofilms. Colony-forming unit (CFU) was a measure of microbials, and the amount of microbials in biofilm was reported in “Logic) CFU” unit. “Log Reduction” was a mathematical term used to show the amount of microbials being reduced in relative to the test that neither probiotic nor chemical treatment was performed.

TABLE 1

| Treatment of P. aeruginosa | | | | |
|---|---|---|---|---|
| Biofilms | | Log₁₀ CFU of | CFU of | Log |
| Probiotic | Chemical | P. aeruginosa | P. aeruginosa | Reduction of |
| Treatment | Treatment | (mean ± S.D.) | (mean) | P. aeruginosa |
| — | — | 10.34 ± 0.28 | 21,877,616,239 | — |
| E. Coli | — | 10.45 ± 0.27 | 28,183,829,313 | 0 |
| — | Hydrogen Peroxide | 5.74 ± 0.91 | 549,541 | 4.6 |
| — | Quat Ammonium | 8.82 ± 0.15 | 660,693,448 | 1.52 |
| E. Coli | Hydrogen Peroxide | 1.65 ± 1.55 | 45 | 8.69 |
| E. Coli | Quat Ammonium | 7.32 ± 0.35 | 20,892,961 | 3.02 |

When E. coli probiotic was used alone to control P. aeruginosa in biofilms, E. coli probiotic essentially did not provide any microefficacy against P. aeruginosa in biofilms (log reduction of about 0). When hydrogen peroxide was used alone to control P. aeruginosa in biofilms, a log reduction of 4.6 was observed. Surprisingly and unexpectedly, a synergistic microefficacy effect against P. aeruginosa in biofilms was observed when E. coli probiotic was used in combination with hydrogen peroxide chemical disinfectant, as indicated by a substantially significant reduction of P. aeruginosa in biofilms (i.e., a log reduction of 8.69).

When quaternary ammonium was used alone to control P. aeruginosa in biofilms, a reduction of 1.52 was observed. Surprisingly and unexpectedly, a synergistic microefficacy effect against P. aeruginosa in biofilms was observed when E. coli probiotic was used in combination with quaternary ammonium chemical disinfectant, as indicated by a substantially significant reduction of P. aeruginosa in biofilms (i.e., a log reduction of 3.02).

### Example 2

Example 2 tested the microefficacy of probiotic treatment and/or chemical disinfectant treatments against P. aeruginosa biofilms. Probiotic treatment was performed using the procedure as described in Example 1, except that P. polymyxa was used the probiotic species instead of E. Coli. Chemical disinfectant treatment was performed according to the EPA Standard Operating Procedure Method Number MB-20-01, as described in Example 1 at a contact time of 3 minutes. One chemical disinfectant contained 0.27% hydrogen peroxide (“Hydrogen Peroxide”) as the disinfecting agent; the other chemical disinfectant contained 0.066% quaternary ammonium (“Quat Ammonium”) as the disinfecting agent.

TABLE 2 showed the microefficacy of probiotic treatment and/or chemical disinfectant treatments against P. aeruginosa in biofilms.

TABLE 2

| Treatment of P. aeruginosa | | | | |
|---|---|---|---|---|
| Biofilms | | Log₁₀ CFU of | CFU of | Log |
| Probiotic | Chemical | P. aeruginosa | P. aeruginosa | Reduction of |
| Treatment | Treatment | (mean ± S.D.) | (mean) | P. aeruginosa |
| — | — | 8.20 ± 0.02 | 158,489,319 | — |
| P. polymyxa | — | 6.17 ± 0.03 | 1,479,108 | 2.03 |
| — | Hydrogen Peroxide | 4.83 ± 0.48 | 67,608 | 3.37 |
| — | Quat Ammonium | 6.87 ± 0.27 | 7,413,102 | 1.33 |
| P. polymyxa | Hydrogen Peroxide | Less than 2 | less than 100 | 6.2 |
| P. polymyxa | Quat Ammonium | Less than 2 | less than 100 | 6.2 |

When P. polymyxa probiotic was used alone to control P. aeruginosa in biofilms, a log reduction of about 2.03 was achieved. When hydrogen peroxide was used alone to control P. aeruginosa in biofilms, a log reduction of 3.37 was observed. A synergistic microefficacy effect against P. aeruginosa in biofilms was observed when P. polymyxa probiotic was used in combination with hydrogen peroxide chemical disinfectant, as indicated by a log reduction of 6.2.

When quaternary ammonium was used alone to control P. aeruginosa in biofilms, a reduction of 1.33 was observed. Surprisingly and unexpectedly, a synergistic microefficacy effect against P. aeruginosa in biofilms was observed when P. polymyxa probiotic was used in combination with quaternary ammonium chemical disinfectant, as indicated by a substantially significant reduction of P. aeruginosa in biofilms (i.e., a log reduction of 6.2).

### Example 3

Example 3 tested the microefficacy of probiotic treatment and/or chemical disinfectant treatments against P. aeruginosa biofilms. Probiotic treatment was performed using the procedure as described in Example 1, except that L. lactis was used the probiotic species instead of E. Coli Chemical disinfectant treatment was performed as described in Example 1 at a contact time of 3 minutes. One chemical disinfectant contained 0.27% hydrogen peroxide (“Hydrogen Peroxide”) as the disinfecting agent; the other chemical disinfectant contained 0.066% quaternary ammonium (“Quat Ammonium”) as the disinfecting agent.

TABLE 3

| Treatment of P. aeruginosa | | | | |
|---|---|---|---|---|
| Biofilms | | Log₁₀ CFU of | CFU of | Log |
| Probiotic | Chemical | P. aeruginosa | P. aeruginosa | Reduction of |
| Treatment | Treatment | (mean ± S.D.) | (mean) | P. aeruginosa |
| — | — | 9.82 ± 0.30 | 6,606,934,480 | — |
| L. lactis | — | 9.30 ± 0.05 | 1,995,262,315 | 0.52 |
| — | Hydrogen Peroxide | 7.31 ± 0.40 | 20,417,379 | 2.51 |
| — | Quat Ammonium | 9.14 ± 0.08 | 1,380,384,265 | 0.68 |
| L. lactis | Hydrogen Peroxide | 5.50 ± 0.45 | 316,228 | 4.32 |
| L. lactis | Quat Ammonium | 9.09 ± 0.08 | 1,230,268,771 | 0.73 |

TABLE 3 showed the microefficacy of probiotic treatment and/or chemical disinfectant treatments against P. aeruginosa in biofilms. A synergistic microefficacy effect against P. aeruginosa in biofilms was observed when L. lactis probiotic was used in combination with chemical disinfectant.

### Example 4

Example 4 tested the microefficacy of probiotic treatment and/or chemical disinfectant treatments against S. aureus biofilms. Probiotic treatment was performed using the procedure as described in Example 1, except that S. aureus was used as the biofilm species instead of P. aeruginosa and that L. lactis was used the probiotic species instead of E Co/i. Chemical disinfectant treatment was performed as described in Example 1 at a contact time of 3 minutes. One chemical disinfectant contained 0.27% hydrogen peroxide (“Hydrogen Peroxide”) as the disinfecting agent; the other chemical disinfectant contained 0.066% quaternary ammonium (“Quat Ammonium”) as the disinfecting agent.

TABLE 4

| Treatment of S. aureus | | | | |
|---|---|---|---|---|
| Biofilms | | Log₁₀ CFU of | CFU of | Log |
| Probiotic | Chemical | S. aureus. | S. aureus | Reduction of |
| Treatment | Treatment | (mean ± S.D.) | (mean) | S. aureus |
| — | — | 8.38 ± 0.33 | 239,883,292 | — |
| L. lactis | — | 4.82 ± 0.12 | 66,069 | 3.56 |
| — | Hydrogen Peroxide | 5.33 ± 1.27 | 213,796 | 3.05 |
| — | Quat Ammonium | 7.92 ± 0.12 | 83,176,377 | 0.46 |
| L. lactis | Hydrogen Peroxide | less than 2 | less than 100 | 6.38 |
| L. lactis | Quat Ammonium | less than 2 | less than 100 | 6.38 |

TABLE 4 showed the microefficacy of probiotic treatment and/or chemical disinfectant treatments against S. aureus in biofilms. A synergistic microefficacy effect against S. aureus in biofilms was observed when L. lactis probiotic was used in combination with chemical disinfectant.

### Example 5

Example 5 tested the microefficacy of probiotic treatment and/or chemical disinfectant treatments against the biofilms that was composed of three microbial species: S. aureus, L. innocua, and P. aeruginosa. The biofilms were grown using the procedure as described in Example 1, with S. aureus, L. innocua, and P. aeruginosa being inoculated at a 1:1:1 ratio at the beginning of the batch phase.

Probiotic treatment was performed using the procedure as described in Example 1, except that L. lactis was used the probiotic species instead of E. Coli. Chemical disinfectant treatment was performed as described in Example 1 at a contact time of 3 minutes. One chemical disinfectant contained 0.27% hydrogen peroxide (“Hydrogen Peroxide”) as the disinfecting agent; the other chemical disinfectant contained 0.066% quaternary ammonium (“Quat Ammonium”) as the disinfecting agent.

TABLE 5 showed the microefficacy of probiotic treatment and/or chemical disinfectant treatments against S. aureus, L. innocua, and P. aeruginosa in the biofilms.

TABLE 5

| Treatment of Biofilms that composed of | | | | |
|---|---|---|---|---|
| S. aureus, L. innocua, and P. aeruginosa | | | | |
| Probiotic | Chemical | Log₁₀ CFU (mean value) | | |
| Treatment | Treatment | S. aureus | L. innocua | P. aeruginosa |
| — | — | 7.07 | 7.79 | 9.31 |
| L. lactis | — | 0.00 | 4.64 | 8.55 |
| — | Hydrogen Peroxide | 5.87 | 6.09 | 7.69 |
| — | Quat Ammonium | 4.95 | 4.77 | 7.90 |
| L. lactis | Hydrogen Peroxide | 0.00 | 1.58 | 5.76 |
| L. lactis | Quat Ammonium | 0.00 | 0.40 | 7.51 |

As shown in TABLE 5, L. lactis showed strong microefficacy against S. aureus with a complete elimination of S. aureus m the biofilm. By combining the probiotic treatment and the chemical treatment, a synergistic microefficacy was achieved against both P. aeruginosa and L. innocua in the biofilm.

TABLE 6 showed the microefficacy of probiotic treatment and/or chemical disinfectant treatments against L. innocua in the biofilms that was composed of three microbial species: S. aureus, L. innocua, and P. aeruginosa (herein after “Three-Species Biofilm”).

TABLE 6

| Treatment of L. innocua | | | | |
|---|---|---|---|---|
| in the Three-Species Biofilms | | Log₁₀ CFU of | CFU of | Log |
| Probiotic | | L. innocua | L. innocua | Reduction of |
| Treatment | Chemical Treatment | (mean value) | (mean value) | L. innocua |
| — | — | 7.79 | 61,659,500 | — |
| L. lactis | — | 4.64 | 43,652 | 3.15 |
| — | Hydrogen Peroxide | 6.09 | 1,230,269 | 1.7 |
| — | Quat Ammonium | 4.77 | 58,884 | 3.02 |
| L. lactis | Hydrogen Peroxide | 1.58 | 38 | 6.21 |
| L. lactis | Quat Ammonium | 0.40 | 3 | 7.39 |

When L. lactis probiotic was used alone to control L. innocua in the three-species biofilms, a log reduction of 3.15 was observed. When hydrogen peroxide was used alone to control L. innocua in three-species biofilms, a log reduction of 1.7 was observed. Surprisingly and unexpectedly, a synergistic microefficacy effect against L. innocua in the three-species biofilms was observed when L. lactis probiotic was used in combination with hydrogen peroxide chemical disinfectant, as indicated by a substantially significant reduction of L. innocua in the three-species biofilms (i.e., a log reduction of 6.21). When quaternary ammonium was used alone to control L. innocua in three-species biofilms, a reduction of 3.02 was observed. A synergistic microefficacy effect against L. innocua in the three-species biofilms was observed when L. lactis probiotic was used in combination with quaternary ammonium chemical disinfectant, as indicated by a significant reduction of L. innocua in the three-species biofilms (i.e., a log reduction of 7.39).

TABLE 7 showed the microefficacy of probiotic treatment and/or chemical disinfectant treatments against P. aeruginosa in the three-species biofilm.

TABLE 7

| Treatment of P. aeruginosa | | | | |
|---|---|---|---|---|
| in the Three-Species Biofilms | | Log₁₀ CFU of | CFU of | Log |
| Probiotic | Chemical | P. aeruginosa | P. aeruginosa | Reduction of |
| Treatment | Treatment | (mean value) | (mean value) | P. aeruginosa |
| — | — | 9.31 | 2,041,737,944 | 0 |
| L. lactis | — | 8.55 | 354,813,389 | 0.76 |
| — | Hydrogen Peroxide | 7.69 | 48,977,882 | 1.62 |
| — | Quat Ammonium | 7.90 | 79,432,823 | 1.41 |
| L. lactis | Hydrogen Peroxide | 5.76 | 575,440 | 3.55 |
| L. lactis | Quat Ammonium | 7.51 | 32,359,366 | 1.8 |

When L. lactis probiotic was used alone to control P. aeruginosa in the three-species biofilms, a log reduction of 0.76 was observed. When chemical treatment such as hydrogen peroxide was used alone to control P. aeruginosa in three-species biofilms, a log reduction of 1.62 was observed. A synergistic microefficacy effect against P. aeruginosa in the three-species biofilms was observed when L. lactis probiotic was used in combination with hydrogen peroxide chemical disinfectant, as indicated by a significant reduction of L. Innocua in the three-species biofilms (i.e., a log reduction of 3.55).

### Example 6

Example 6 tested the microefficacy of probiotic treatment and/or chemical disinfectant treatments against the Listeria spp. biofilms that was formed on the floor surface of several retail grocery stores, in the real world environment (“field test”). Field tests were conducted in five retail grocery stores: stores “A”, “B”, “C”, “D”, and “E”).

Environmental swab was taken from the floor surface to test for Listeria spp. A positive result indicated the presence of Listeria spp. on the floor surface, while a negative result indicated the absence of Listeria spp. on the floor surface. Multiple environmental swabs were taken to calculate a percentage of positive samples. A lower positive percentage was desired, as it indicated a higher reduction of Listeria spp. on the treated surface.

“Probiotic Treatment” was performed daily on the floor surface of each store for a period of four weeks using a composition that contained probiotic species as active agent at approximately 10⁶ CFU of bacteria spores/mL. At a selected time, environmental swabs were taken from the floor surface to test from Listeria spp.

“Probiotic and Chemical Treatment” was performed for two weeks using a composition that contained both probiotic species at approximately 10⁶ CFU of bacteria spores/mL and quaternary ammonium chemical disinfectant at 300 ppm. At a selected time, environmental swabs were taken from the floor surface to test from Listeria spp.

TABLE 8 showed the control of the Listeria spp. biofilms in retail grocery stores, comparing the “Probiotic Treatment” to the “Probiotic and Chemical Treatment.” The microefficacy against the Listeria spp. biofilms was reported as the percentage positive finding of Listeria spp. on the treated surface (“Positive Percentage”). A lower positive percentage indicated a higher reduction of Listeria spp. on the treated surface.

TABLE 8

| | Probiotic Treatment | | | Probiotic and Chemical Treatments | | |
|---|---|---|---|---|---|---|
| | Number of | Number of | Positive | Number of | Number of | Positive |
| Store | Sample | Positive | Percentage | Sample | Positive | Percentage |
| A | 20 | 4 | 20% | 45 | 6 | 13% |
| B | 20 | 7 | 35% | 45 | 6 | 13% |
| C | 20 | 12 | 60% | 45 | 6 | 13% |
| D | 20 | 19 | 95% | 45 | 32 | 71% |
| E | 20 | 16 | 80% | 45 | 27 | 60% |

| | | | |
|---|---|---|---|
| Overall Positive | 58% | Overall Positive | 34% |

For each tested grocery retail stores, the positive percentage of Listeria spp. for the Probiotic and Chemical Treatment was significantly lower than that of the Probiotic Treatment.

Various features and advantages of the invention are set forth in the following claims.

1. A method of controlling a biofilm, comprising:
contacting the biofilm with probiotic species; and
contacting the biofilm with chemical disinfectant,
wherein the method provides a higher reduction in the amount of at least one microbial species in the biofilm, compared to a similar method applying only the chemical disinfectant.

2. The method of claim 1, wherein the biofilm is contacted with the probiotic species and the chemical disinfectant simultaneously.

3. The method of claim 1, wherein contacting the biofilm with the probiotic species is performed before contacting the biofilm with the chemical disinfectant.

4. The method of claim 1, wherein contacting the biofilm with the chemical disinfectant is performed before contacting the biofilm with the probiotic species.

5. The method of claim 1, wherein the method provides a synergistic effect between the probiotic species and the chemical disinfectant in controlling the biofilm.

6. The method of claim 1, wherein the biofilm is a single-species biofilm.

7. The method of claim 1, wherein the biofilm is a multiple-species biofilm comprising at least two microbial species.

8. The method of claim 1, wherein the biofilm comprises Aspergillus niger, Listeria innocua, Pseudomonas aeruginosa, Staphylococcus aureus, or any combination thereof.

9. The method of claim 1, wherein the probiotic species comprises Acetoanaerobium, Aerococcaceae, Bacillaceae, Carnobacteriaceae, Enterococcaceae, Lactobacillaceae, Leuconostocaceae, Paembacillaceae, Propionibacteriaceae, Enterobacteriaceae, Pseudomonadaceae, Streptococcaceae, or any combination thereof.

10. The method of claim 1, wherein the probiotic species comprises Citrobacter freundii, Lactobacillus acidophilus, Lactococcus lactis, Lactobacillus salivarius, Paenibacillus polymyxa, Escherichia coli, or any combination thereof.

11. The method of claim 1, wherein the chemical disinfectant comprises disinfecting agent that fulfills at least ones of the following:
(a) the disinfecting agent is selected from quaternary ammonium, hydrogen peroxide, glutaraldehyde, sodium hypochlorite, alcohols, peroxy or peroxo acids, sulfur-nitrogen compounds, hypochlorous aid, chlorine dioxide, ozone, organic acids, acid-anionics, or any combination thereof;
(b) the disinfecting agent is present in an amount of from about 0.01% to about 10% by weight based on total weight of the chemical disinfectant.

12. The method of claim 1, wherein the chemical disinfectant comprises quaternary ammonium or hydrogen peroxide.

13. The method of claim 1, wherein the chemical disinfectant comprises from about 0.005% to about 10% by weight of hydrogen peroxide based on total weight of the chemical disinfectant.

14. The method of claim 1, wherein the chemical disinfectant comprises from about 0.005% to about 10% by weight of quaternary ammonium based on total weight of the chemical disinfectant.

15. The method of claim 1, wherein the biofilm is on a surface comprising appliance surface, carpet, curtain, door, door handle, drains electronic device surface, filter, floor, floor care machine and component, countertop, furniture surface, food contact surface, human skin, HVAC component, ducting, mattress surface, pipe, shower head, sink, tubing, wall, or any combination thereof.

16. The method of claim 1, wherein:
the biofilm is contacted with the probiotic species and the chemical disinfectant simultaneously;
the probiotic species comprises Bacillaceae; and
the chemical disinfectant comprises quaternary ammonium or hydrogen peroxide.

17. The method of claim 16, wherein the method provides a synergistic effect between the probiotic species and the chemical disinfectant in controlling the biofilm.

18. The method of claim 16, wherein the chemical disinfectant comprises from about 0.005% to about 10% by weight of the quaternary ammonium based on total weight of the chemical disinfectant.

19. The method of claim 18, wherein the method provides a synergistic effect between the probiotic species and the chemical disinfectant in controlling the biofilm.

20. The method of claim 19, wherein the biofilm is on a surface comprising appliance surface, carpet, curtain, door, door handle, drains electronic device surface, filter, floor, floor care machine and component, countertop, furniture surface, food contact surface, human skin, HVAC component, ducting, mattress surface, pipe, shower head, sink, tubing, wall, or any combination thereof.
